(19) United States
(12) Patent Application Publication
(10) Pub. No.: US 2006/0139863 A1
(43) Pub. Date: Jun. 29, 2006

(54) COMPUTER DISPLAY JOINT

(75) Inventors: Tien-Chang Lin, Taipei (TW); Steven Wang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/047,460

(22) Filed: Jan. 28, 2005

(30) Foreign Application Priority Data
Dec. 24, 2004 (TW) 093220834

(51) Int. Cl. G06F 1/16

(52) U.S. Cl. 361/683

(57) ABSTRACT

A notebook computer display is disclosed having a display monitor and a joint portion that is located on a side of the display monitor. The joint portion is connected to the display monitor to support the display monitor and to serve as a reinforcement to prevent stress concentration. With the reinforcement, torsion generated during the folding/unfolding operation of the display monitor is dispersed to other parts of the display monitor, so as to prevent damage to the corner caused by stress concentration, while prolonging the durability of the folding/unfolding mechanism of the display monitor.

### BACKGROUND OF THE INVENTION

1. Field of the Invention

The invention relates to a display design, and more particularly, to a notebook computer display.

2. Description of the Related Art

Miniaturized electronic components allow for portable electronic devices. Such devices must not only be small, but also be durable enough to handle the rough usage associated with portable use. A prominent example is the notebook computer.

A desktop computer differs from a notebook computer in terms of the portability of the notebook. The portability of the notebook is achieved not only by making the processing portion and display monitor more compact, but also by making the notebook components more resistant to shock and stress.

Moreover, a notebook computer is generally designed as a two-piece assembly of a processing/input portion (herein called the processing unit) and a display monitor, the two pieces being connected in such a way that they are capable of folding towards or unfolding from each other. When the notebook computer needs to be stored or carried, it is folded (closed) to protect the vulnerable components of the assembly, such as the keyboard and, more significantly, the liquid crystal display. When usage is desired, the notebook is unfolded to expose the keyboard and the liquid crystal display to a user. Thus, the folding/unfolding capability not only makes the notebook more compact when stored or carried, but also protects the vulnerable components of the notebook. In addition, this folding/unfolding capability also allows the angle of the display monitor to be adjusted to an optimum viewing angle for the user, and such adjustments may happen frequently during usage to maintain optimal viewing according to the changing posture of the user.

To ensure that the notebook computer can achieve the above-mentioned folding/unfolding operation over a long lifespan, the folding/unfolding mechanism should be designed carefully with respect to its structural strength and it should be able to pass durability testing after manufacture. In terms of the above-mentioned folding/unfolding operation, the notebook computer must pass a swing open/close test according to a predefined specification (for example, twenty-five thousand times depending on the size specification). Afterwards, if breakage or even cracks occur in the notebook unit under test, the unit would be classified as defective. Moreover, if too many defects occurred, the design itself would be considered unsuitable for mass production.

As illustrated in FIG. 1, a typical notebook computer is assembled from a display monitor 1 and a processing unit 2. The display monitor 1 is usually formed with a joint portion 11 projecting from a bottom side thereof, and the processing unit 2 is designed with a corresponding base 21 thereon for receiving the joint portion 11, so as to facilitate the folding/unfolding operation between the display monitor 1 and the processing unit 2. Typically, the joint portion 11 is formed with a jointer, such as a pivot, and the processing unit 21 is formed with corresponding bearings to pivotally join with the jointer.

In the actual operation of the swing open/close test, the most common reason for test failure is inferiority in the design of the joint portion 11 of the display monitor 1. Referring to FIG. 2, the joint portion 11 is shown to project from the display monitor at its bottom side, such that an inverted corner 13 is formed at the intersection of the three straight planes where the joint portion is connected, unquestionably forming a stress concentration point. As the display monitor 1 is folded and unfolded, a torsion type force is generated during the operation that can definitely cause damage at the point of stress concentration. Thus, the corner 13 subject to the stress concentration is vulnerable to cracking 131, and the cracks 131 may even lead to the display monitor 1 breaking apart from the joint portion 11 during swing open/close testing.

In response, designers have designed a rib inside the corresponding corner of the display monitor for improving the structural strength of the corner 13. However, such design is still insufficient to either redistribute or withstand the stress that causes damage, resulting in an undesirably high number of test failures after the display monitor is subjected to the swing open/close test for twenty thousand times.

In that neither of the designs disclosed in the prior art above adequately provide a durable foldable computer display, an effective solution is needed. In particular, a solution is needed that overcomes the problem of stress being concentrated at the inverted corners of the display monitor where the joint portion is connected.

### SUMMARY OF THE INVENTION

In light of the above and other drawbacks, an objective of the present invention is to provide a notebook computer display capable of alleviating stress concentration at the corners thereof.

Another objective of the present invention is to provide a notebook computer display having a folding/unfolding mechanism with prolonged durability.

In accordance with the above and other objectives, the present invention proposes a notebook computer display, comprising a display monitor and a joint portion, the joint portion being located on a side of the display monitor, wherein the joint portion is connected to a corner of the display monitor to serve as a reinforcing structure for preventing stress concentration. The joint portion has the reinforcing structure connected to each of the two lower, lateral corners of the display monitor which connect it to the base of the processing unit. The reinforcing structure is an inverted corner located where the joint portion joins with the display monitor. Preferably, the inverted corner is an arc-shaped inverted corner.

Alternatively, the reinforcing structure may be an arc body integrated in the inverted corner. Preferably, the arc body is integrally formed with the corner of the display monitor.

The joint portion is formed with a jointer component. Preferably, the jointer is a pivot.

The display monitor comprises at least a front cover and a rear cover assembled to each other. Generally, the display monitor further comprises a display panel such as a liquid crystal display panel formed between the front and rear covers.

According to the present invention, the reinforcing structure is formed at the corners of display monitor where the joint portion is connected to prevent stress concentration. Since torsion generated by folding/unfolding the display monitor is dispersed to other parts of the display monitor, damage to the corner is prevented and the durability of the folding/unfolding mechanism is prolonged. Therefore, several drawbacks associated with the prior arts are overcome to improve commercial applicability of the present invention.

To provide a further understanding of the invention, the following detailed description with reference to drawings illustrates embodiments and examples of the invention, it being understood that this detailed description is provided only for illustration of the invention and not as a limitation to the scope of this invention.

### BRIEF DESCRIPTION OF THE DRAWINGS

The drawings included herein provide a further understanding of the invention. A brief introduction of the drawings is as follows:

FIG. 1 is a schematic diagram illustrating a conventional notebook computer;

FIG. 2 is a magnified view of a portion of FIG. 1.

FIG. 3 is a schematic diagram illustrating construction of a notebook computer display according to a first embodiment of the present invention.

FIG. 4 is a magnified view of a portion of FIG. 3; and

FIG. 5 is a schematic diagram illustrating construction of the notebook computer display according to a second embodiment of the present invention.

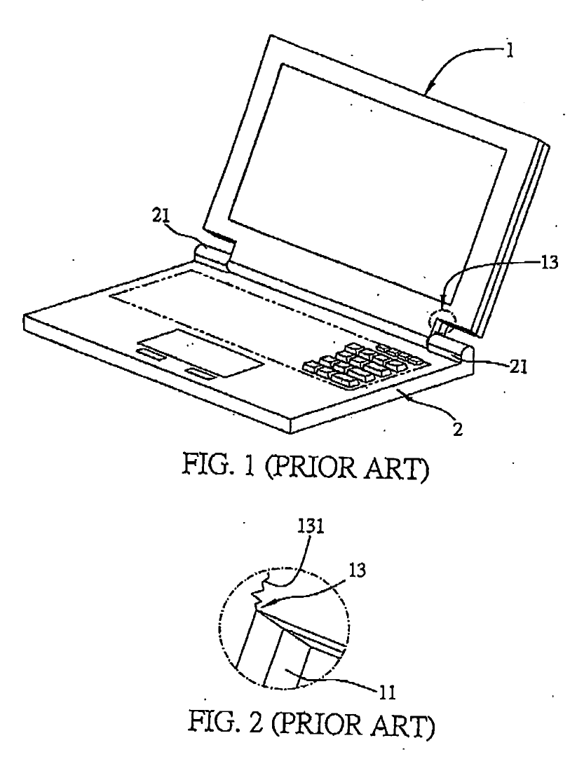

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

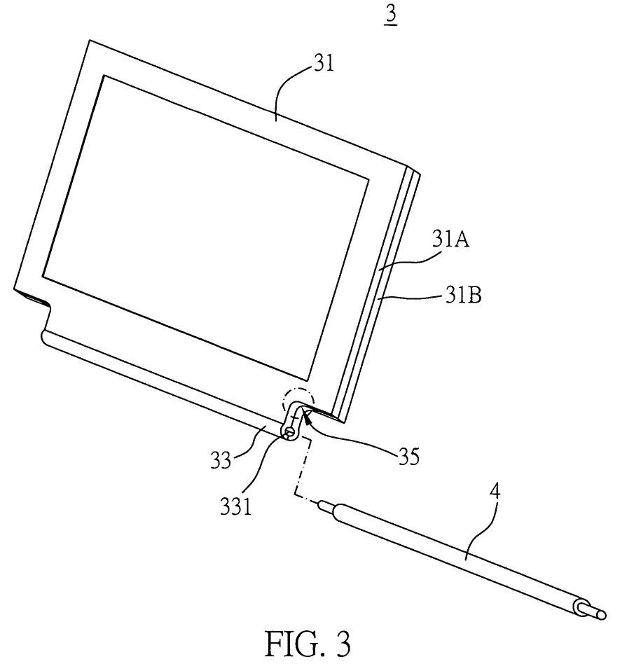

FIG. 3 is a schematic diagram illustrating the notebook computer display according to the first embodiment of the present invention. As shown in FIG. 3, the notebook computer display 3 comprises a display monitor 31 and a joint portion 33 located on a side (typically the bottom) of the display monitor 31. The joint portion 33 is connected at the ends to the display monitor 31 to serve as a reinforcing structure 35 to alleviate stress concentration.

In this embodiment of the present invention, the notebook computer display 3 may be a liquid crystal display that comprises an assembly of a front cover 31A and a rear cover 31B. A liquid liquid crystal panel (not labeled) is formed between the front cover 31A and the rear cover 31B. The joint portion 33 is centered on and extends along much of the bottom side of the display monitor 31, and may be formed by assembling from the bottom portion of the front cover 31A and the bottom portion of the rear cover 31B. The joint portion 33 has a through-hole 331 for accommodating a jointer 4. The jointer 4 may be a pivot or a pivot set having a damping effect.

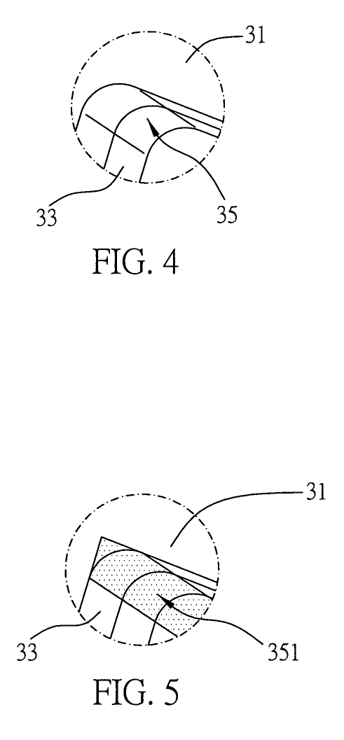

Referring to FIG. 4, there is one reinforcing structure 35 on each of the two sides of the joint portion 33 connected to the display monitor 31. In the present embodiment, the reinforcing structure 35 is constructed as an inverted corner located at the points of attachment between the joint portion 33 and the display monitor 31, the inverted corner preferably being a circular arc-shaped inverted corner.

By means of the circular arc-shaped inverted corner of the reinforcing structure 35, there is a beneficial release of stress and transmission of force through the material. Therefore, torsion generated during folding and unfolding of the notebook computer display 3 is dispersed to other parts of the display monitor 31 to prevent damage to the inverted corner caused by stress concentration. Thus, a notebook computer assembled with the notebook computer display 3 can alleviate formation of stress concentration points at the inverted corners connecting the display monitor 31 and the joint portion 33. As the torsion generated from the folding/unfolding operation of the notebook computer display 3 is dispersed to other parts of the display monitor 31, the notebook computer can pass swing open/close testing at the predefined specification (e.g. twenty-five thousands times, depending on the size specification) and overcome the problem of cracking or breakage occurring during testing and normal usage to increase the durability of the folding/unfolding mechanism of the notebook computer.

Even though the display monitor 31 is portrayed in the present embodiment as a front cover 31A and a rear cover 31B assembled to each other, such that the reinforcing structure, such as circular arc shaped inverted corner, is formed from a portion of the front cover 31A and a portion of the rear cover 31B, it should be noted that the display monitor 31 might also utilize a modularized design. For example, the display monitor may be assembled from a front cover and the back panel of the assembled liquid crystal module, where the reinforcing structure 35 of the circular arc-shaped inverted corner is formed only in the front cover rather than being limited to the above embodiment.

Furthermore, the reinforcing structure construction 35 is not limited to the circular arc-shaped inverted corner design described in the above embodiment as long as the design may prevent stress concentration. FIG. 5 is a schematic diagram illustrating a notebook computer display according to a second embodiment of the present invention. As illustrated in FIG. 5, there is one reinforcing structure 351 formed at the corner on either of two sides of the joint portion 33 connected to the display monitor 31. In the present embodiment, the reinforcing structure 351 is an arc body integrated into the corner. The construction of the reinforcing structure 351, such as the arc body, may be integrally formed with the corner of the display monitor 31. And no matter whether the arc body reinforcing structure 35/351 is integrally formed or constructed as an additional part, it provides for release and transmission of the stress at the corner and external stress, thereby reducing the possibility of damage to the corner caused by stress concentration.

According to the present invention, the reinforcing structure is formed at the inverted corner of the display monitor where the joint portion and display monitor are connected to prevent stress concentration, so that torsion generated during folding/unfolding is dispersed to other parts of the display monitor. As a result, the inverted corner is prevented from damage and the durability of the folding/unfolding mechanism of the display monitor is prolonged. Thus, drawbacks associated with prior art are overcome to improve the commercial applicability of the present invention.

It should be apparent to those skilled in the art that the above description is only illustrative of specific embodiments and examples of the invention. The invention should therefore cover various modifications and variations that can be made to the herein-described structure and operation of the invention, provided that they fall within the scope of the invention as defined in the following appended claims.

1. A notebook computer display, comprising:
a display monitor; and
a joint portion, located on a side of the display monitor, wherein the joint portion is connected to a corner of the display monitor to serve as a reinforcing structure for alleviating stress concentration, and the reinforcing structure is an arc body integrated with the corner.

2-4. (canceled)

5. The notebook computer display of claim 1, wherein the joint portion has two reinforcing structures connected to two lateral corners of the display monitor.

6. The notebook computer display of claim 1, wherein the joint portion is formed with a jointer.

7. The notebook computer display of claim 6, wherein the jointer is a pivot.

8. The notebook computer display of claim 1, wherein the composition of the display monitor is comprised of at least a front cover and a rear cover assembled to each other.

9. The notebook computer display of claim 8, wherein the display monitor further comprises a display panel between the front and rear covers.

10. The notebook computer display of claim 9, wherein the display panel is a liquid crystal display panel.

11. The notebook computer display of claim 1, wherein the joint portion is located on a bottom side of the display monitor.
